(19) United States
(12) Patent Application Publication
(10) Pub. No.: US 2007/0207801 A1
(43) Pub. Date: Sep. 6, 2007

(54) Telecommunications Method and System

(76) Inventors: Eric Careel, Meudon (FR); Sebastien Royer De La Bastie, Paris (FR)

Correspondence Address: JOSEPH J. LAKS, VICE PRESIDENT;THOMSON LICENSING LLC, PATENT OPERATIONS, PO BOX 5312, PRINCETON, NJ, 08543-5312, US

(21) Appl. No.: 10/552,501

(22) PCT Filed: Apr. 6, 2004
(86) PCT No.: PCT/IB04/01042

§ 371 Date: Mar. 20, 2007

(30) Foreign Application Priority Data
Apr. 8, 2003 (FR) 03 04339

(51) Int. Cl. H04Q 7/20

(52) U.S. Cl. 455/426.1

(57) ABSTRACT

Telecommunication method using at least a first telecommunication device in radio communication with a first public network, wherein the first telecommunication device is caused to communicate locally with a second telecommunication device which is turn capable of communicating with a second public network, such that the first and second telecommunication devices are part of a local area communication network. The first telecommunication device is controlled from the second telecommunication device and an outgoing call is transmitted from the local area communication network either to the first public network via the first telecommunication device or to the second public network.

The present invention relates to telecommunications methods and systems.

More particularly, the invention relates to a telecommunications method using at least a first telecommunications device that is adapted for radio communication with a first public network according to a first radiocommunication protocol, method in which the first telecommunications device is made to communicate locally with at least a second telecommunications device that is itself adapted for communicating with a second public network, the first and second telecommunications devices thus belonging to a local communication network (that can include other telecommunications devices if necessary).

It should be noted that in general, the local communication between the first and second telecommunications devices can be realized by a wire or contact link, a radio link or another contactless link. The second telecommunications device can be for example a radiocommunication local network central base such as a “BLUETOOTH”, “WIFI” or “DECT” network, or the said second telecommunications device could even be a mobile terminal belonging to such a local network, or simply a fixed telephone connected to the second public network, or any other telecommunications device linked directly to indirectly to the second public network. The second public network can be the public switched telephone network, or another.

The document EP-A-1 257 136 describes an example of such a method, which enables a mobile radiocommunication terminal to be integrated into a local telecommunications network.

The particular purpose of this invention is to perfect the methods of the above-mentioned type, so as to provide the user with more functions.

For this purpose, according to the invention, a method of the kind in question is characterized in that the first telecommunications device is controlled from the second telecommunications device and an outgoing call is sent over the local communication network, either to the first public network by means of the first telecommunications device, or to the second public network.

Thanks to these arrangements, the user therefore benefits from the advantages of an additional telephone line (or several additional lines if several first telecommunications devices are linked with the second telecommunications device), without experiencing the drawbacks (particularly additional subscription fees and extra wiring).

In various embodiments of the method according to the invention, recourse can also possibly be made to one and/or other of the following arrangements:
a user is required to choose between the transmission of an outgoing call by the first public network and by the second public network,

an automatic choice is made between the transmission of the outgoing call by the first public network and by the second public network,

an outgoing call transmission is automatically chosen by the second network, except if the communication with the said second network is unavailable,

a user is required to validate the automatic choice,

the local communication network is a local radio network comprising a fixed base linked with the second public network according to a second radiocommunication protocol, and the second telecommunications device is either the base or the local network terminal,

the first telecommunications device is made to communicate with the second telecommunications device according to the said second radiocommunication protocol,

the said radiocommunication protocol is chosen from: “BLUETOOTH”, “WIFI” and “DECT”,

the first public network is a cellular radiocommunication network and the second public network is a switched telephone network,

the method comprises an identification stage during which it is determined whether the first telecommunications device is connected to the second telecommunications device, and a routing stage during which, when it has been determined that the first telecommunications device is connected to the second telecommunications device, an incoming call is routed to the first telecommunications device, when the said incoming call is normally intended to be routed to the local switched network by the second public network and when the said local communication network is unavailable to receive this incoming call,

the method comprises an identification stage during which it is determined whether the first telecommunications device is connected to the second telecommunications device, and a routing stage during which, when it has been determined that the first telecommunications device is connected to the second telecommunications device, an incoming call normally intended to set up a link with the first telecommunications device, is routed to the local switched network by means of the second public network (this incoming call can then be rerouted by the first network if the communication between the local network and the second network is unavailable, as explained above),

at least the first telecommunications device comprises a telephone directory, and this telephone directory is made accessible by means of the second telecommunications device.

Moreover, the subject of the invention is also a telecommunications system comprising at least the first and second telecommunications devices, the first telecommunications device being adapted for radio communication with a first public network according to a first radiocommunication protocol, and the first telecommunications device being adapted to communicate at least with the second telecommunications device which is itself adapted to communicate with a second public network, the first and second telecommunications devices thus belonging to a local communication network, characterized in that the second telecommunications device is adapted to control the first telecommunications device and to send an outgoing call of the local communication network either to the first public network by means of the first telecommunications device, or to the second public network.

In various embodiments of the telecommunications system according to the invention, recourse can possibly also be made to one and/or other of the following arrangements:

the second telecommunications device is adapted so that a user is required to choose between the transmission of an outgoing call by the first public network and by the second public network (this choice can be made, according to the case, on this second telecommunications device, or on another device communicating with the said second telecommunications device),

the second telecommunications device is adapted to make an automatic choice about the transmission of the outgoing call by the second network, except if the said second network is unavailable,

the second telecommunications device is adapted to require the user to validate the automatic choice,

the local communication network is a local radio network comprising a fixed base linked with the second public network and at least one local network terminal communicating with the base according to a second radiocommunication protocol, and the second telecommunications device is either the base or the local network terminal,

the first telecommunications device is adapted to communicate with the second telecommunications device according to the said second radiocommunication protocol,

the said radiocommunication protocol is chosen from: “BLUETOOTH”, “WIFI” and “DECT”,

the first public network is a cellular radiocommunication network and the second public network is a switched telephone network,

Other characteristics and advantages of the invention will emerge from the following non-restrictive description of one of its embodiments, given as an example, with regard to the drawing attached.

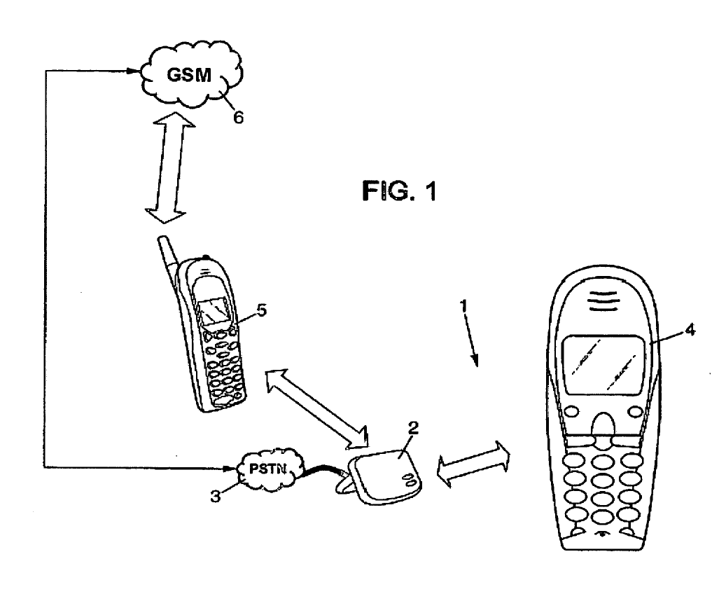

In the drawing, FIG. 1 is a diagrammatic view of a telecommunications system according to an embodiment of the invention.

The telecommunications system shown in FIG. 1 comprises:

a local radiocommunication network 1, comprising a central fixed base 2 that is connected for example to the public switched telephone network 3 (PSTN) or another public network (this link can be direct or indirect particularly if the base 2 is connected to a PABX itself connected to a public network) and which is adapted to communicate locally with at least one terminal 4 by radio, according to a local radiocommunication protocol, particularly the “BLUETOOTH” protocol or even the “WIFI” protocol or the “DECT” protocol,

at least one radiocommunication mobile terminal 5 such as a mobile phone or other device, adapted to communicate with a public radiocommunication network 6, particularly a cellular network operating for example according to the “GSM” radiocommunication protocol (or even the “UMTS” protocol or any other cellular radiocommunication protocol).

The mobile terminal 5 is adapted to communicate with the base 2 according to the above-mentioned local radiocommunication protocol, for example the “BLUETOOTH” protocol. For this purpose, the “BLUETOOTH” link already provided on many mobile phones can be used advantageously with a portable earphone and microphone (headset): in this case, the mobile terminal 5 is already configured to be controlled by the “BLUETOOTH” link, so that the implementation of the invention is very inexpensive and only requires the suitable programming of the base 2.

In a variant, the mobile terminal 5 can communicate with the base 2 by a different link from the link between the base 2 and the terminals of the local network 1: for example, the link between the base 2 and the mobile terminal 5 can be a “BLUETOOTH” link, whereas the link between the base 2 and the terminals 4 of the local network 1 can be a “DECT” link. More generally, the link between the mobile terminal 5 and the base 2 can if necessary be of a type other than a radio link, for example, a very short distance contactless induction or optical link, or even an electrical contact link or wire link.

Moreover, the mobile terminal 5 can communicate with the terminal 4 of the local network, rather than with the base 2, particularly with a “BLUETOOTH” link as described above.

The base 2 can also be replaced, if necessary, by any telecommunications device connected to the public network 3, for example a fixed telephone line featuring means for communicating locally with the mobile terminal. 5.

According to the invention, when the mobile terminal 5 is within range of the base 2, it communicates with the base by its “BLUETOOTH” link means and is identified on the said base. The base 2 can then check, for example, whether the mobile terminal 5 belongs to a predetermined list of terminals.

For instance, the local radiocommunication network 1 can be installed particularly in domestic or professional premises, and the predetermined list in question can contain for example the identification of one or more GSM mobile terminals 5 belonging to the occupant(s) of the premises in question.

Once this link is established, the mobile terminal 5 can at least be controlled by the base 2, and it can possibly be fully integrated into the local network 1 if it has the “CTP” (Cordless Telephony Profile) function in the “BLUETOOTH” standard: in the latter case, the mobile terminal 5 can then be used like any other terminal 4 of the local network 1.

Moreover, in all the cases, the base 2 can then access the telephone directory of the terminal 5 and make it accessible to the other terminals 4 for consultation and/or for dialling a number. More generally, data between the terminal 4 and the rest of the local network 1 can be shared; this data can be physically stored either in the terminal 5 or in the terminal 4, or in the base 2. The data in question comprises not only phonebooks (which can contain other items than telephone numbers), but also diaries, lists of things to do, notes or other.

Moreover, in all the cases, the aforementioned arrangements especially enable an outgoing call of the local communication network 1 (therefore sent from the terminal 4 or terminal 5) to be sent selectively either to the GSM network 6 by means of terminal 5, or to the switched telephone network 3 by means of the base 2.

This choice can if necessary be purely manual, in which case the user is required to choose (particularly by means of the keypad and the screen of the terminal 4 or terminal 5, depending on the terminal that the call is from), between the transmission of the outgoing call by the first public network (6) and by the second public network (3).

As a variant, the base 2 can, for any outgoing call, make an automatic choice between sending the outgoing call by the GSM network 6 and by the switched telephone network 3.

For example, the base 2 can automatically choose to send the outgoing call by the switched telephone network 3, except if the communication with the said network is unavailable (namely, if the line of the base 2 is busy).

Advantageously, even when this choice automatic, the base 2 can if necessary require the user to validate it (particularly by means of the keypad and the screen of the terminal 4 or terminal 5, depending on the terminal that the call is from).

The user of the local communication network 1 thus benefits from the equivalent of two telephone lines, for sending calls to the exterior.

More generally, if n mobile radiocommunication terminals 5 are linked to the base 2, the user benefits from the equivalent of n+1 telephone lines. More exactly, if n is greater than the number p of devices able to communicate simultaneously with the base 2, the user has a maximum of p+1 telephone lines distributed among the n GSM mobile terminals 5 and the terminals 4.

Still more generally, the invention can provide the user with the functions of a PABX featuring a single local network 1, at low cost.

Moreover, when the base 2 recognises the mobile terminal 5 as one of those on its list of predetermined terminals, it can if necessary send a message to the switched network 3, which will then also inform the GSM network 6 of the fact the mobile terminal 5 is temporarily integrated into the local radiocommunication network 1. As a variant, the mobile terminal 5 can itself alert the GSM network 6 of the fact that it is linked to the base 2 (by running a software included in terminal 5, or on the order of the base 2, by running a software included on the same base). In the latter case, if necessary, it would be possible to design that the GSM network 6 itself notifies the switched network 3 of the fact that the mobile terminal 5 is linked to the base 2, in which case it may be necessary for the base 2 to alert the switched network 3.

In this embodiment of the invention, the networks 3 and 6 can, if necessary after this identification stage, carry out specific routing on the incoming calls intended for the mobile terminal 5 or for the base 1:

when an exterior incoming call was intended to set up a link with the mobile terminal 5 by the GSM 6 network (this is therefore a call to the number of the mobile terminal 5), then the incoming call in question is redirected by the GSM network 6 to the switched network 3, to the number of the base 2, which enables a communication to be set up with the user of the mobile terminal 5 for the least cost, by means of the switched network 3,

when the base 2 receives an incoming call by the switched network 3 but the said base is unavailable, or for example because the line is busy, then the switched network 3 redirects the incoming call to the GSM network 6, which then enters into direct communication with the mobile terminal 5.

Although the above description has been made with reference to a switched network 3 and a GSM network 6, it should be noted that the invention is not limited to these two specific types of network, the GSM network 6 being able to be replaced by any first public radiocommunication network and the switched network 3 being able to be replaced if necessary by any second public radiocommunication network.

1. Telecommunications method using at least one first telecommunications device that is adapted for radio communication with a first public network according to a first radiocommunication protocol, method in which the first telecommunications device is made to communicate locally with at least a second telecommunications device that is itself adapted for communicating with a second public network, the first and second telecommunications devices thus belonging to a local communication network, wherein the first telecommunications device is controlled from the second telecommunications device and an outgoing call of the local communication network is sent either to the first public network by means of the first telecommunications device, or to the second public network.

2. Method according to claim 1, in which a user is required to choose between the transmission of the outgoing call by the first public network Hand by the second public network.

3. Method according to claim 1, in which an automatic choice is determined between the transmission of the outgoing call by the first public network and by the second public network.

4. Method according to claim 3, in which an outgoing call transmission is automatically chosen by the second network, except if the communication with the said second network is unavailable.

5. Method according to claim 3, in which a user is required to validate the automatic choice.

6. Method according to claim 1, in which the local communication network is a local radio network comprising a fixed base linked with the second public network and to at least one local network terminal communicating with the base according to a second radiocommunication protocol, and the second telecommunications device is either the base or the local network terminal.

7. Method according to claim 6, in which the first telecommunications device is made to communicate with the second telecommunications device according to the said second radiocommunication protocol.

8. Method according to claim 6, in which the said radiocommunication protocol is chosen from: “BLUETOOTH”, “WIFI” and “DECT”.

9. Method according to claim 1, in which the first public network is a cellular radiocommunication network and the second public network is a switched telephone network.

10. Method according to claim 1, comprising an identification stage during which it is determined whether the first telecommunications device is connected to the second telecommunications device, and a routing stage during which, when it has been determined that the first telecommunications device is connected to the second telecommunications device, an incoming call is routed to the first telecommunications device, when the said incoming call is normally intended to be routed to the local switched network by the second public network and when the said local communication network is unavailable to receive this incoming call.

11. Method according to claim 1, comprising an identification stage during which it is determined whether the first telecommunications device is connected to the second telecommunications device, and a routing stage during which, when it has been determined that the first telecommunications device is connected to the second telecommunications device, an incoming call normally intended to set up a link with the first telecommunications device, is routed to the local communication network by means of the second public network.

12. Method according to claim 1, in which at least the first telecommunications device comprises a telephone phonebook, and this telephone phonebook is made accessible by means of the second telecommunications device.

13. Telecommunications system comprising at least the first and second telecommunications devices, the first telecommunications device being adapted for radio communication with a first public network according to a first radiocommunication protocol, and the first telecommunications device being adapted to communicate at least with the second telecommunications device, which is itself adapted to communicate with a second public network, the first and second telecommunications devices thus belonging to a local communication network, wherein the second telecommunications device is adapted to control the first telecommunications device and to send an outgoing call of the local communication network either to the first public network by means of the first telecommunications device, or to the second public network.

14. Telecommunications system according to claim 13, in which the second telecommunications device is adapted so that a user is required to choose between the transmission of an outgoing call by the first public network and the second public network.

15. Telecommunications system according to claim 13, in which the second telecommunications device is adapted to make an automatic choice between the transmission of the outgoing call by the first public network and the second public network.

16. Telecommunications system according to claim 15, in which the second telecommunications device is adapted to make an automatic choice about the transmission of the outgoing call by the second network, except if the communication with the said second network is unavailable.

17. Telecommunications system according to claim 15, in which the second telecommunications device is adapted to require the user to validate the automatic choice.

18. Telecommunications system according to claim 13, in which the local communication network is a local radio network comprising a fixed base linked with the second public network and at least one local network terminal communicating with the base according to a second radiocommunication protocol, and the second telecommunications device is either the base or the local network terminal.

19. Telecommunications system according to claim 18, in which the first telecommunications device is adapted to communicate with the second telecommunications device according to the said second radiocommunication protocol.

20. Telecommunications system according to claim 18, in which the said radiocommunication protocol is chosen from: “BLUETOOTH”, “WIFI” and “DECT”

21. Telecommunications system according to claim 13, in which the first public network His a cellular radiocommunication network and the second public network is a switched telephone network
